(19) United States
(12) Patent Application Publication
(10) Pub. No.: US 2005/0107930 A1
(43) Pub. Date: May 19, 2005

(54) System for managing vehicle travel record utilizing infrared data association

(76) Inventor: Jae Kyu Park, Jeonju-city (KR)

Correspondence Address: MORGAN, LEWIS & BOCKIUS LLP (SF), 2 PALO ALTO SQUARE, PALO ALTO, CA, 94306, US

(21) Appl. No.: 10/993,949

(22) Filed: Nov. 18, 2004

(30) Foreign Application Priority Data
Nov. 18, 2003 (KR) 10-2003-0081837

(51) Int. Cl. G01M 17/00

(52) U.S. Cl. 701/35; 701/200

(57) ABSTRACT

A digital tachograph and a terminal of a system for managing vehicle travel information are provided with infrared data communication portions such that communication of the vehicle travel record therebetween is realized through the infrared data communication portions.

### CROSS-REFERENCE TO RELATED APPLICATIONS

This application claims priority of Korean Application No. 10-2003-0081837, filed Nov. 18, 2003, the disclosure of which is incorporated herein by reference.

### FIELD OF THE INVENTION

Generally, the present invention relates to a system for managing a vehicle travel record that records, saves, and manages a data file of vehicle travel information. More particularly, the present invention relates to a system for managing a vehicle travel record which can transfer a data file in a tachograph to a separate terminal or a printer through infrared data association.

### BACKGROUND OF THE INVENTION

Generally, a tachograph is a device for recording vehicle speeds, travel distances, and stationary time. Such a digital tachograph stores travel records as a data file in a built-in memory, and visually displays or transfers them to a separated terminal, e.g., a personal computer (PC).

In conventional systems for managing a vehicle travel record, vehicle travel information is inputted to a digital tachograph through the controller area network (CAN) communication line of a vehicle. The digital tachograph accumulates the travel information to form the vehicle travel record, and stores it in a memory. The vehicle travel record stored in the memory may be sent to a data logger through an on-board diagnosis (OBD) connector and an output terminal of the CAN communication line, and subsequently may be transferred to a PC through a RS-232 cable.

According to such a conventional system, a data logger for intermediating data between the digital tachograph and the PC is necessarily required, and cable connection for data communication become complex.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

Embodiments of the present invention provide a system for managing a vehicle travel record that has a number of advantages, including direct communication between a digital tachograph and a PC (or a printer), utilizing infrared data association and cableless communication for communication of data stored in a tachograph.

An exemplary system for managing a vehicle travel record according to an embodiment of the present invention includes a digital tachograph and a terminal. The digital tachograph receives vehicle travel information through a network in a vehicle, and forms, saves, and displays a vehicle travel record therefrom. The terminal receives the vehicle travel record from the digital tachograph, and is for saving and managing the received vehicle travel record. The digital tachograph and the terminal are provided with infrared data communication portions such that communication of the vehicle travel record therebetween is realized through the infrared data communication portions.

In a further embodiment, the digital tachograph includes a central processing unit for processing received vehicle travel information by a predetermined program, a memory for storing data of a travel record processed in the central processing unit, a display device for displaying the data of the travel record stored in the memory, and an infrared data communication portion for transmitting the data of the travel record.

Another exemplary system for managing a vehicle travel record includes a digital tachograph and a printer. The digital tachograph receives vehicle travel information through a network means provided in a vehicle, and forms, saves, and displays a vehicle travel record therefrom. The printer prints data of the travel record transmitted from the digital tachograph. The digital tachograph and the printer are provided with infrared data communication portions such that they communicate with each other therethrough.

In a further embodiment, the digital tachograph includes a central processing unit for processing received vehicle travel information by a predetermined program, a memory for storing data of a travel record processed in the central processing unit, a display device for displaying the data of the travel record stored in the memory, and an infrared data communication portion for transmitting the data of the travel record. The printer includes an infrared data communication portion for receiving the data of the travel record, a central processing unit for processing the data of the travel record received through the infrared data communication portion, and a printing means for printing the data of the travel record processed by the central processing unit.

An exemplary digital tachograph according to the present invention receives vehicle travel information through a network of a vehicle, and forms, saves, and displays a vehicle travel record therefrom. Such an exemplary digital tachograph according to the present invention includes a central processing unit for processing received vehicle travel information by a predetermined program, a memory for storing data of a vehicle travel record processed in the central processing unit, a display device for displaying the data of the vehicle travel record stored in the memory, and an infrared data communication portion for transmitting the data of the vehicle travel record through infrared data communication.

An exemplary printer according to the present invention prints data of a vehicle travel record transmitted from a digital tachograph provided in a vehicle, wherein the vehicle travel record is transmitted through infrared data communication. Such an exemplary printer according to the present invention includes an infrared data communication portion for receiving the data of the vehicle travel record through the infrared data communication, a central processing unit for processing the data of the vehicle travel record received through the infrared data communication portion, and a printing means for printing the data of the vehicle travel record processed by the central processing unit.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of a system for managing a vehicle travel record according to a first embodiment of the present invention; and

FIG. 2 is a block diagram of a system for managing a vehicle travel record according to a second embodiment of the present invention.

### DETAILED DESCRIPTION OF THE PREFERRED EMBODIMENTS

An embodiment of the present invention will hereinafter be described in detail with reference to the accompanying drawings.

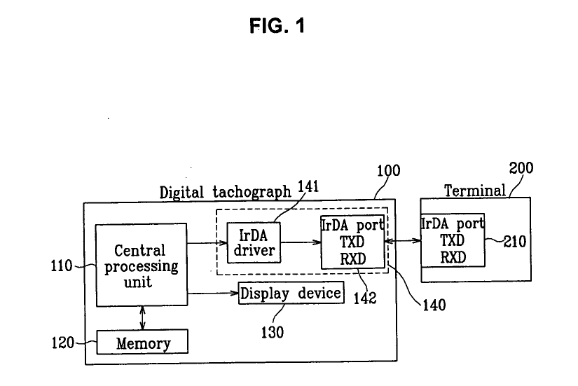

As shown in FIG. 1, a system for managing a vehicle travel record according to an embodiment of the present invention includes a digital tachograph 100 and a terminal 200. The digital tachograph 100 includes a central processing unit 110, a memory 120, a display device 130, and an infrared data communication portion 140.

The central processing unit 110 receives signals for travel information from a plurality of sensors and switches etc. equipped in a vehicle. Such travel information may include, for example, vehicle speed, utilizing, for example a tachograph which is a device enabling recording, processing, and managing of vehicle speed with respect to time. Therefore, sensors/switches that provide information to the CPU 110 may include a speed sensor for detecting the vehicle speed. Such a vehicle speed sensor is usually mounted to an output shaft of a transmission, and Hall IC type may be used. A variety of other information may also be input and displayed to a driver, and in this case, various other sensors/switches may be further adopted, such as an engine speed sensor for detecting an engine speed and a brake switch for detecting a brake operation. The signals for travel information are inputted preferably through a controller area network (CAN) association line. Inputted signals for travel information are processed by a predetermined program so as to produce data of a vehicle travel record.

The data of a vehicle travel record processed in the central processing unit 110 are stored in the memory 120. The data of the travel record stored in the memory 120 may be retrieved by the central processing unit 110, and accordingly the retrieved data may be shown in the display device 130 or exteriorly transmitted through the infrared data communication portion 140. The display device 130 may be preferably realized as an LCD display device. The infrared data communication portion 140 includes an infrared data association (IrDA) driver 141 and an infrared data communication port 142.

Preferably, the terminal 200 may be a portable computer equipped with an infrared data communication portion 210 such that it may communicate with the digital tachograph 100 through the infrared data association in order to receive the vehicle travel information. A universal asynchronous receiver-transmitter (UART) communication method utilizing two pins of TXD and RXD is preferably applied to data communication between the infrared data communication portion 140 of the digital tachograph 100 and the infrared data communication portion 210 of the terminal 200. Received data of travel records are processed, stored, and managed by a predetermined program of the terminal 200.

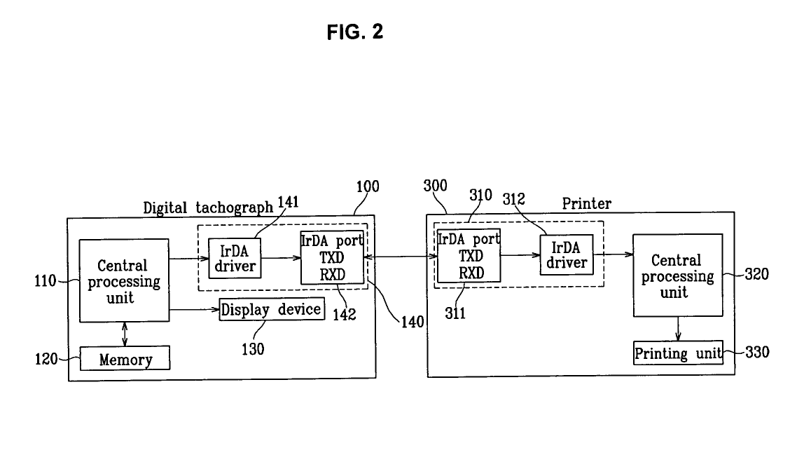

As shown in FIG. 2, a system for managing a vehicle travel record according to an embodiment of the present invention includes a digital tachograph 100 and a printer 300. The digital tachograph 100 may be the same as has been described in connection with FIG. 1.

The printer 300 outputs data of a travel record transmitted from the digital tachograph 100, and includes an infrared data communication portion 310, a central processing unit 320, and a printing device 330. The infrared data communication portion 310 communicates with the infrared data communication portion 140 of the digital tachograph 100 through infrared data communication, and receives data of vehicle travel records therefrom.

The UART method also may be applied to the data communication between the infrared data communication portion 140 of the digital tachograph 100 and the infrared data communication portion 310 of the printer 300. The infrared communication portion 310 may include an infrared data association (IrDA) driver 312 and an infrared data communication port 311 for communicating with the infrared data communication port 142 through an infrared data communication.

The central processing unit 320 transforms the data of the travel record received through the infrared data communication portion 310 into a format suitable for printing. In order for this, the central processing unit 320 executes a predetermined program for such transformation of data. Data of the travel record processed by the central processing unit 320 is printed on paper by the printing device.

Therefore, according to a system for managing a vehicle travel record of an embodiment of the present invention, data of a travel record stored in a digital tachograph may be directly transferred to a terminal or a printer without an additional apparatus such as a data logger. Therefore, management and/or printing of such data of a travel record becomes efficient.

In addition, data transmission between a digital tachograph, a terminal, and a printer is realized through infrared data communication. Since such communication does not require cables, a system for managing a vehicle travel record becomes simplified.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A system for managing a vehicle travel record, comprising:
a digital tachograph for receiving vehicle travel information through a network in a vehicle, and for forming, saving, and displaying a vehicle travel record therefrom; and
a terminal for receiving the vehicle travel record from the digital tachograph and for saving and managing the received vehicle travel record,
wherein the digital tachograph and the terminal are provided with infrared data communication portions such that communication of the vehicle travel record therebetween is realized through the infrared data communication portions.

2. The system of claim 1, wherein the digital tachograph comprises:
a central processing unit for processing received vehicle travel information by a predetermined program;
a memory for storing data of a travel record processed in the central processing unit;
a display device for displaying the data of the travel record stored in the memory; and
an infrared data communication portion for transmitting the data of the travel record.

3. A system for managing a vehicle travel record, comprising:
a digital tachograph for receiving vehicle travel information through a network means provided in a vehicle, and for forming, saving, and displaying a vehicle travel record therefrom; and
a printer for printing data of the travel record transmitted from the digital tachograph,
wherein the digital tachograph and the printer are provided with infrared data communication portions such that they communicate with each other therethrough.

4. The system of claim 3, wherein the digital tachograph comprises
a central processing unit for processing received vehicle travel information by a predetermined program,
a memory for storing data of a travel record processed in the central processing unit,
a display device for displaying the data of the travel record stored in the memory, and
an infrared data communication portion for transmitting the data of the travel record,
wherein the printer comprises:
an infrared data communication portion for receiving the data of the travel record;
a central processing unit for, by a predetermined program, processing the data of the travel record received through the infrared data communication portion; and,
a printing means for printing the data of the travel record processed by the central processing unit.

5. A digital tachograph for receiving vehicle travel information through a network of a vehicle, and for forming, saving, and displaying a vehicle travel record therefrom, the digital tachograph comprising:
a central processing unit for processing received vehicle travel information by a predetermined program;
a memory for storing data of the vehicle travel record processed in the central processing unit;
a display device for displaying the data of the vehicle travel record stored in the memory; and
an infrared data communication portion for transmitting the data of the vehicle travel record through infrared data communication.

6. A printer for printing data of a vehicle travel record transmitted from a digital tachograph provided in a vehicle, the vehicle travel record being transmitted through infrared data communication, the printer comprising:
an infrared data communication portion for receiving the data of the vehicle travel record through the infrared data communication;
a central processing unit for processing, by a predetermined program, the data of the vehicle travel record received through the infrared data communication portion; and
printing means for printing the data of the vehicle travel record processed by the central processing unit.
